(19) United States
(12) Patent Application Publication
(10) Pub. No.: US 2004/0137229 A1
(43) Pub. Date: Jul. 15, 2004

(54) Autocatalytic nickel-boron coating process for diamond particles

(75) Inventors: Mandar Shyam Mudholkar, Dublin, OH (US); Richard John Goetz, Dublin, OH (US)

Correspondence Address: Hanh T. Pham, GE Plastics - 123571-2 60SD, One Plastics Avenue, Pittsfield, MA, 01201, US

(73) Assignee: General Electric Company

(21) Appl. No.: 10/744,689

(22) Filed: Dec. 23, 2003

Related U.S. Application Data
(60) Provisional application No. 60/438,957, filed on Jan. 9, 2003.

(51) Int. Cl. B05D 7/00; B32B 15/02

(52) U.S. Cl. 428/403; 427/212

(57) ABSTRACT

A method for preparing coated diamond particles comprising the steps of coating the diamond particles with nickel in the presence of a reducing agent having a pH ranging of from about 6 to 10, and recovering the diamond particles coated with nickel/boron (Ni/B) wherein the Ni/B coating contains less than about 5 wt-% boron content. Coated diamond particles are used in abrasive tools/cutting elements such as grinding wheels, saw segments, drill bits and the like.

### CROSS-REFERENCE TO RELATED APPLICATIONS

This patent application claims priority to U.S. Provisional Application No. 60/438957 with a filing date of Jan. 9, 2003.

### FIELD OF THE INVENTION

The present invention relates to abrasive cutting tools containing metal coated superabrasive particles or grit, and the use of nickel-boron coated particles in abrasive or cutting tools, e.g. resin bond wheels, to improve the performance of such tools.

### BACKGROUND OF THE INVENTION

The coating of diamond and cubic boron nitride (CBN) with nickel, nickel-phosphorous alloys, cobalt, cobalt-phosphorous alloys, copper, and various combinations thereof is a standard procedure in the industry for enhancing retention of the abrasives in resin bonded tools and for enhancing the grinding operation, where the coatings enhance the retention of the crystals in the resin bond. Grinding wheels are made from these abrasives by mixing the coated diamond with resin powders and other additives (SiC, Cu powders), pressing the mixture in a mold and heating to cure the resin.

Conventional autocatalytic processes for nickel coating of diamond particles typically are composed of a nickel-phosphorous coating, which contains undesirably high quantities of phosphorous resulting in a porous and weaker coating.

U.S. Pat. No. 6,183,546 discloses the use of borohydride reducing agent at a pH of 10 to 14 to deposit nickel-boron coatings containing 0.5 to 10 wt % boron. The patent describes bath compositions that limit the incorporation of Thalium in the coating, which is used as a stabilizer in the process.

U.S. Pat. No. 6,319,308 describes the use of borohydride reducing agent at a pH of 10 to 14 to co-deposit particles and nickel-boron coating, whereby the particles are dispersed throughout the nickel-boron coating layer.

U.S. Pat. No. 6,066,406 describes the use of borohydride reducing agent at a pH of 10 to 14 to deposit nickel-boron coating, followed by a post-coating heat treatment to increase coating hardness. The patent describes co-deposition of nickel-boron with other metal ions such as cobalt.

U.S. Pat. No. 5,188,643 describes a method of improving adhesion of nickel-boron coating to surface of cubic boron nitride particles using post-coating heat treatment in non-oxidizing environments.

U.S. Pat. No. 4,407,869 discloses the use of zirconyl and vanadyl ions to increase the boron content of nickel-boron coatings using an amine-borane based reducer, wherein the electroless bath comprises stabilizers and co-deposition enhancers to incorporate higher boron content in the nickel-boron deposits.

U.S. Pat. No. 5,024,680 describes multiple metal coated superabrasive grit, where metal vapor deposition is used to form a metal carbide layer, followed by chemical vapor deposition to form a second oxidation-resistant metal layer, followed by a third metal layer that is either electroplated or electrolessly deposited.

U.S. Pat. No. 5,062,865 discloses a method to chemically bond a coating layer to superabrasive grit using metal vapor deposition technique, wherein a carbide forming metal is used as the first deposited layer, followed by an electrolessly coated second metal layer that protects the first layer from any oxidization.

U.S. Pat. No. 5,224,969 describes multiple metal coated superabrasives, where a first metal layer is deposited by metal vapor deposition to form a carbide, a second metal layer is deposited using chemical vapor deposition on the first layer and then nitrided, and then a third metal layer is deposited which bonds to the matrix material.

There is still a need for coated diamond particles with improved wear and corrosion resistant coating for use in abrasive or cutting tools, and tools having improved performance and properties.

### BRIEF SUMMARY OF THE INVENTION

The invention relates to a method for preparing nickel coated diamond particles comprising the steps of pre-treating diamond particles, coating nickel from a nickel salt onto the pre-treated diamond particles in the presence of a reducing agent within a pH range of from about 6 to 10, at a reaction temperature ranging from between about 40° C. and 95° C., wherein the nickel/boron coated diamond particles are recovered with a nickel/boron coating containing less than about 5 wt-% boron. In one embodiment, the reducing agent is dimethylamineborane.

The invention further relates to an abrasive cutting element comprising a matrix and coated diamond particles bonded to the matrix, having a nickel boron (Ni/B) coating layer chemically bonded directly to the diamond particles, and wherein the Ni/B coating contains less than about 5 wt-% boron content.

Lastly, the invention relates to diamond particles comprising a nickel boron (Ni/B) coating layer bonded directly to the diamond particles, wherein the Ni/B coating contains less than about 5 wt-% boron content, and wherein the coating is prepared in a metal coating bath having a pH in the range of about 6 to 10 and at a reaction temperature ranging from between about 40° C. and 95° C., and containing an amine-borane reducing agent and a source of Ni.

### BRIEF DESCRIPTION OF THE DRAWINGS

FIG. 1 is a graph comparing the relative performance of Ni/P coated diamond particles to Ni/B coated diamond particles in one embodiment of the invention, as reported in Example 1; and

FIG. 2 is another plot of the relative performance of Ni/P coated cBN particles to Ni/B coated cBN particles, as reported in Example 2.

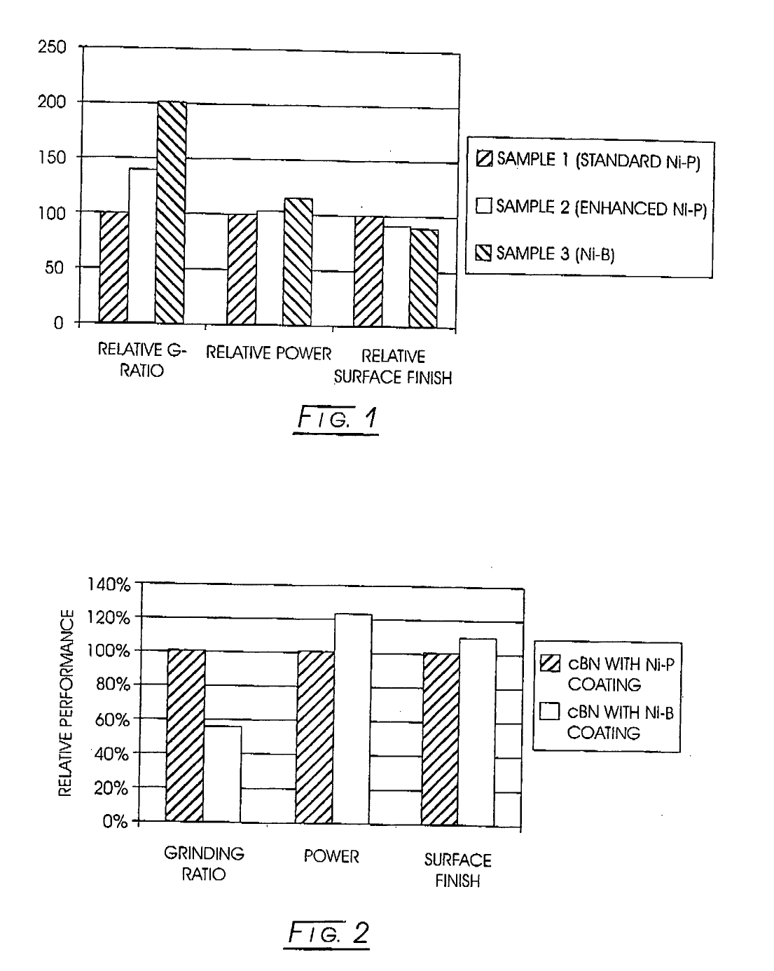

### DETAILED DESCRIPTION OF THE INVENTION

Coated Diamond Particles.

The present invention relates to diamond particles coated with Ni/B, rather than conventional Ni/P in order to improve the performance of abrasive or cutting tools, e.g., resin bonded grinding elements or wheels.

In one embodiment of the invention, the process of forming the Ni/B coated diamond particles follows accepted procedures that are used in coating the exterior surfaces of diamond. For example, the diamond particles may be first pre-treated in order to render their surfaces receptive to metal coating. Next, the pre-treated particles need to be coated, and finally they are recovered.

In one embodiment with a pre-treatment step of the process, in order to coat diamond particles, they are cleaned with deioinized (DI) water, and then activated, for example, using a standard 2-step stannous chloride/palladium chloride activation. Other activation sequences also can be practiced, including a 1-step activation using commercially available strike solutions such as MacDermid D34C or the like, as those skilled in the art will appreciate.

The particles then are transferred to a heated reaction vessel containing a suitable coating bath solution. The coating bath solution contains a nickel source, such as a nickel salt (e.g., nickel sulfate, nickel chloride, or nickel sulfamate). The coating bath is maintained at a suitable pH (in the range of about 6 to 10), at a reaction temperature ranging from between about 40° C. and 95° C. The coating bath also can be agitated, for example by means of a mechanical agitator. The reaction proceeds with addition of a reducing agent, e.g., borane compounds and the like. Examples include an amine-borane such as dimethylamineborane (DMAB) and diethylamineborane (DEAB). In one embodiment, the reducing agent is DMAB.

The process may be controlled such that the desired boron content is attained in the Ni/B coating. In one embodiment, the boron content ranges from between about 0.05 to 0.5 wt-% of the coating. In a second embodiment, the boron content ranges from between about 0.1 to 0.4 wt-% of the coating. In a third embodiment, the boron content ranges from between about 0.5 to 0.3 wt-% of the coating. In yet another embodiment of the invention, the diamond particles are uniformly coated with the Ni/B coating containing less than about 5 wt-% boron.

The reaction sequence may be repeated until the desired nickel-boron coating thickness is attained. As used herein, diamond particles “coated” with Ni/B means that at least 25% of the total surface area of an individual diamond particle is covered with a coating of Ni/B.

In one embodiment, the Ni/B coating ranges from between about 0.05-30 wt-% of the diamond particles. In a second embodiment, the Ni/B coating ranges from between about 0.1 to 60 wt-% of the diamond particles. In a third embodiment, the Ni/B coating ranges from between about 30-80 wt-% of the diamond particles. In yet another embodiment of the invention, the diamond particles are coated with a Ni/B coating of up to about 60 wt-% of the diamond particles.

The diamond particles can be natural or synthetic. In one embodiment for a cutting tool used in grinding operations, synthetic diamonds are used. Synthetic diamond can be made by high pressure/high temperature (HP/HT) processes, which are well known in the art. The particle size of the diamond is conventional in size for cutting tools employing diamond. In one embodiment of a resin-bond grinding wheel, the diamond grit ranges in particle size from about 600 mesh (30 microns) upwards to about 40 mesh (425 microns). In another embodiment of conventional grinding technology, narrow particle size distributions are used.

Tool Matrix:

The coated diamond particles of the present invention may be used in a superabrasive cutting tool element, which comprises a matrix with the coated diamond particles bonded to the matrix. The matrix can be a metal, a metal alloy or a resin. The metal alloy typically comprises an alloy of nickel, cobalt, copper or tin.

Examples of resins or organic polymers for use in the matrix include melamine or urea formaldehyde resins, melamine, epoxy resins, polyesters, polyamides, polyurethanes, and polyimides. In one embodiment of the invention, the matrix comprises a phenol-formaldehyde reaction product for its low cost and thermal stability.

In one embodiment of the invention, the tool matrix also includes secondary abrasive particles or fillers, such as silicon carbide, copper or graphite. The filler is used to modify the physical characteristics of the matrix, such as its strength, wear resistance and thermal conductivity. The nominal diameter of the filler is usually less than the nominal diameter of the coated superabrasive particles of the invention.

Concentration of coated diamond and fabrication of tools comprising coated superabrasive particles is conventional and well known in that art. In one embodiment, the concentrations range from about 5 to 200. As used herein, 100 concentration conventionally being defined in the art as 4.4 carats/cm³ with 1 carat equal to 0.2 g, wherein the concentration of diamond grains is linearly related to its carat per unit volume concentration. In a second embodiment, the concentration of diamond grit ranges from about 50-100. In a third embodiment, the concentration of the matrix comprises between 15-20% by volume of coated diamond grit, 20-40% by volume of filler and the remainder resin.

Cutting Tools Employing the Coated Diamond of the Invention.

The cutting tools may be in the form of a saw blade segment, a drill bit, or a grinding wheel. In one embodiment, the tools are grinding wheels of disc shape or cup shape for use in grinding hard materials such as tungsten carbide.

In one embodiment of a preparation of a resin bond grinding wheel, a mixture of granulated resin, Ni/B coated diamond abrasive particles, and filler is placed in a mold. A pressure appropriate to the particular resin, usually several thousand pounds per square inch (several tens of thousands of Kilo Pascals, KPa), is applied, and the mold is heated to a temperature sufficient to make the resin plastically deform (and cure when the resin is heat-curable).

In one example to prepare the cutting tool element, the desired amount of diamond grit coated in accordance with the present invention is mixed with a powder of the matrix. In a metal matrix, the powder can comprise, for example, a mixture of 70% bronze (85% copper 15% tin) and 30% cobalt. The mixture is hot pressed in a graphite container at 790° C. and 5,000 psi for 3 minutes. A cutting tool in accordance with the present invention comprises an abrasive cutting element, as described above, attached to a support.

In an embodiment of the invention wherein the cutting tool employs a resin matrix, e.g., phenol formaldehyde, the resin is ground to a fine powder and mixed with the filler and coated superabrasive particles. The mixture is placed in a hardened steel mold and placed between the platens of a hydraulic press at a temperature of about 160° C. The mold is closed under a pressure of 2-5 tons per square inch for about 30 minutes. In another embodiment wherein a polyimide is used, the temperature of the press is set between 350-450° C. with pressures of 5-20 tons per square inch.

### EXAMPLES

Examples are provided herein to illustrate the invention but are not intended to limit the scope of the invention.

### Example 1

A bath containing nickel sulfate source with 13 gm/L of nickel is used to plate diamond particles with a reducer containing 5% dimethylamineborane (DMAB). The bath is maintained at 70° C. and a pH of 8. A 56 wt-% nickel-boron coating is obtained in 12 passes with uniform diamond particle coverage.

The Ni—B coating is evaluated using standard abrasives in a resin-bond wheel. One of the typical applications for such a wheel is tungsten carbide grinding, which is used to evaluate relative performance of the nickel-boron coating. Two different coatings are used in the test: Sample 1 is deposited using a standard sodium hypophosphite based nickel coating (standard Ni—P); and Sample 2 is deposited with the inventive nickel-boron coating (Ni/B). The following tables show the wheel specifications and grinding test conditions:

TABLE 1
Wheel Specifications:

| | |
|---|---|
| Wheel Type | 1A1 |
| Wheel Diameter | 7.0″ (178 mm) |
| Wheel Rim Width | 0.250″ (6.4 mm) |
| Abrasive Rim Depth | 0.125″ (3.2 mm) |
| Mesh Size | 120/140 |
| Concentration | 100 |
| Bond Type | Phenolic Resin - Medium Hardness |
| Abrasive Type | Diamond |

TABLE 2
Grinding Test Conditions:

| | |
|---|---|
| Grind Mode | Reciprocating (upcut and downcut) |
| Wheel Speed | 5,5000 SFPM (28 m/sec) |
| Depth of Cut | 0.0010″ (0.025 mm) |
| Table Speed | 50 fpm (15.2 m/min) |
| Matl. Rem. Rate Q^{/}_{w} (120/140) | 0.60 in³/in/min (6.3 mm³/mm/sec) |
| Workpiece Material | WC (ISO P30) |

The relative performance data from the grinding wheel tests is shown in the following table. Three primary performance variables are determined based on the grinding tests: Grinding Ratio (G Ratio), Power, and Surface Finish.

TABLE 3
Grinding Test Results

| | Sample 1 (Standard Ni—P) | Sample 2 (Ni—B) |
|---|---|---|
| Relative G-Ratio | 100 | 201 |
| Relative Power | 100 | 115 |
| Relative Surface Finish | 100 | 89 |

G-Ratio: Higher is better.
Power: Lower is better.
Surface Finish: Lower is better.

Based on the grinding test results, the Ni—B coating surprisingly outperformed the standard Ni—P coating, showing a 100% improvement in G-ratio, and a better surface finish compared to the standard Ni—P coating.

### Example 2

In these tests, the inventive Ni/B coating on cBN particles is compared to a conventional Ni/P coating on cBN particles. The samples are prepared in the manner as described in Example 1. The cBN samples are not heat-treated following coating. These results, then, can be compared to the results reported in Table 3. The following cBN grinding results are obtained:

TABLE 4
Grinding Test Results

| | Sample 1 (Standard Ni—P) | Sample 2 (Ni—B) |
|---|---|---|
| Relative G-Ratio | 100 | 56 |
| Relative Power | 100 | 123 |
| Relative Surface Finish | 100 | 109 |

G-Ratio: Higher is better.
Power: Lower is better.
Surface Finish: Lower is better.

As indicated above, the higher Grinding Ratio (G) numbers are better, lower Power numbers are better, and lower Surface Finish (RZD) is better. With this in mind, the above-tabulated data show that the Ni/B coating on cBN perform much worse than the conventional Ni/P coating. These results are contrary to the results reported in Table 3, where the inventive Ni/B coated diamond performed better than conventional Ni/P coated diamond. Ni/B coated cBN particles are disclosed in U.S. Pat. No. 5,188,643. Moreover, other testing revealed that heat-treating Ni/B coated diamond, as taught in U.S. Pat. No. 5,188,643, decreased the toughness of the coated particles. Thus, there appears to be little predictability between Ni/B coated cBN and Ni/B coated diamond particles.

### Example 3

Example 1 is repeated to compare the performance of the uncoated diamond particles with the inventive diamond particles coated with Ni—B.

The coated diamond particles prepared in Example 1 are bonded to a saw blade segment, by mixing the coated grit with a powder of 100% bronze and hot pressing at 800° C. and 5,000 psi for 3 minutes in a graphite container. The diamond concentration of each segment is 7.5 volume percent, or 30 concentration. Uncoated diamond grit saw segments are similarly prepared. The saw segments are bonded to a 14 inch diameter blade for cutting a concrete slab at 2680 RPM and 12 kilowatts power.

Saw blade segments employing the coated diamond particles of the invention are expected to wear out at a rate of ½ that of saw blade segments employing uncoated diamond particles, when cutting the same depth of concrete.

While the invention has been described with reference to a preferred embodiment, those skilled in the art will understand that various changes may be made and equivalents may be substituted for elements thereof without departing from the scope of the invention. All citations referred herein are expressly incorporated herein by reference.

We claim:

1. A method for preparing nickel coated diamond particles, said method comprises the steps of
a. coating the diamond particles with nickel in the presence of a reducing agent having a pH ranging of from about 6 to 10; and
b. recovering the diamond particles coated with nickel/boron (Ni/B) wherein the Ni/B coating contains less than about 5 wt-% boron content.

2. The method of claim 1, further comprises the step of pre-treating the diamond particles prior to coating said diamond particles.

3. The method of claim 2, wherein said diamond particles are pre-treated by washing with deionized water and activating said diamond particles with a 2-step stannous chloride/palladium chloride activation.

4. The method of claim 1, wherein the reducing agent is an amine borane reducing agent.

5. The method of claim 4, wherein the reducing agent is dimethylamineborane.

6. The method of claim 1, wherein said diamond particles are coated in a coating bath containing a source of Ni.

7. The method of claim 6, wherein said source of Ni is a nickel salt.

8. The method of claim 7, wherein said nickel salt is one or more of nickel sulfate, nickel chloride, or nickel sulfate.

9. The method of claim 8, wherein said bath contains an amine borane reducing agent.

10. The method of claim 1, wherein step a. is repeated.

11. The method of claim 1, wherein said recovered nickel/boron coated diamond particles contain a Ni/B coating with a boron content of about 0.05 to 0.5 wt-% of the coating.

12. The method of claim 11, wherein the boron content in the Ni/B coating ranges from between about 0.1 to 0.3 wt-% of the coating.

13. The method of claim 1, wherein said coating step is conducted at a temperature ranging of from about 40° C. to about 95° C.

14. An abrasive cutting element comprising a matrix and coated diamond particles bonded to the matrix, wherein
the coated diamond particles comprising a nickel/boron (Ni/B) coating layer bonded directly to the diamond particles, and wherein the Ni/B coating contains less than about 5 wt-% boron content.

15. The abrasive cutting element of claim 14, wherein the matrix is a resin selected from the group consisting of phenol formaldehyde, thermoplastic polyimide, epoxies, melamine, polyester, polyamide, urea formaldehyde, and polyurethanes, and the Ni/B coated diamond particles being bonded to the resin matrix.

16. The abrasive cutting element of claim 14, wherein the matrix is a metal chosen from the group consisting of nickel, cobalt, copper or tin, or alloys thereof, and the Ni/B coated diamond particles being bonded to the metal matrix.

17. The abrasive cutting element of claim 14, which contains between about 5 and 200 concentration of the Ni/B coated diamond particles.

18. The abrasive cutting element of claim 14, wherein the Ni/B coated diamond particles are prepared in a metal coating bath having a pH in the range of about 6 to 10 and at a reaction temperature ranging from between about 40° C. and 95° C., and containing an amine-borane reducing agent and a source of Ni.

19. The abrasive cutting element of claim 14, wherein the Ni source is a nickel salt.

20. Diamond particles comprising a nickel boron (Ni/B) coating layer bonded directly to the diamond particles,
wherein the Ni/B coating contains less than about 5 wt-% boron content, and
wherein the coating is prepared in a metal coating bath having a pH in the range of about 6 to 10 and at a reaction temperature ranging from between about 40° C. and 95° C., and containing an amine-borane reducing agent and a source of Ni.
